(19) United States
(12) Patent Application Publication
(10) Pub. No.: US 2025/0088580 A1
(43) Pub. Date: Mar. 13, 2025

(54) Mount For Supporting Electronic Devices/Articles on Surfaces

(71) Applicants: Kathy Thornell, Rosemount, MN (US); Alisha Sabouneh, Farmington, MN (US); Brittney Wignall, Farmington, MN (US)

(72) Inventors: Kathy Thornell, Rosemount, MN (US); Alisha Sabouneh, Farmington, MN (US); Brittney Wignall, Farmington, MN (US)

(21) Appl. No.: 18/244,260

(22) Filed: Sep. 10, 2023

(51) Int. Cl. H04M 1/04

(52) U.S. Cl. CPC H04M 1/04

(57) ABSTRACT

A mount for supporting an article on a surface. The mount includes a base having a set of suction cups that removably adhere to the surface. The base is removably attached to the article. The base may be removably attached to the article by an adhering means. The adhering means may be an adhesive that is washable such that such that when the adhesive is washed, one or more contaminants are removed therefrom, and when the adhesive is dried, the adhesive's adhering properties are restored. The base may include a receptacle to accommodate the article.

### FIELD OF THE INVENTION

The disclosure relates generally to a mount for supporting articles on surfaces. Particularly and not exclusively, the subject matter of the instant disclosure relates to the construction and configuration of a mount for supporting articles, such as electronic devices, to vertical, inclined or horizontal surfaces.

### BACKGROUND OF THE INVENTION

For several hand-free applications, it is desirable to have mounts or support apparatuses to hold articles, such as smartphones, cameras, cell phones, tablets, media players, etc., in a suitable position and orientation on a surface. Existing mounts for such articles include complicated parts and components, such as articulated arms and suction supports means. Existing solutions are relatively difficult and expensive to manufacture, and inconvenient to carry and use. For example, when trying to support a smartphone at eye level for a video call while cooking, the articulated arms of existing solutions may consume undesirable amounts of space and may be too bulky to operate for the task. Further such solutions offer limited portability and hence may not be convenient in outdoor use cases.

Another solution uses a set of suction cups attached to the article via a suction base. The suction cups may hold the article in place by adhering to the surface. Such solutions offer improved portability and convenience as the suction cups are attached directly to the article. However, such solutions also tend to have deficiencies, such as being easily detached and moved due to unintentional pull or vibration. Such mounts are also limited in their use on surfaces that are smooth such as windows, mirrors, etc. Furthermore, the suction base is generally attached to the article by adhesives, which may lose their properties and reduce their retention force over time. Since most adhesives cannot be washed to clean off oil and dust, the adhesive loses its efficacy over time, thereby making them unsuitable for reuse. Additionally, when the suction base is detached, it generally leaves a portion of the adhesive material on the article, thereby making the article sticky, attracting dirt, and causing inconvenience to the users.

Therefore, there is a need in the art for a mount for supporting articles on surfaces that removably and reuse-ably adheres to the mounted article without leaving any residue when detached. Further, there is a need for a mount with improved adhesion to surfaces to provide a more secure, stable support to the article on a plurality of surfaces.

### SUMMARY OF THE PRESENT INVENTION

In order to obviate the shortcomings of the background art, a mount for supporting articles to a surface is provided and illustrated in the instant disclosure.

Principally, in accordance with the most preferred embodiment of the instant disclosure, a mount for supporting articles on surfaces is provided. The mount includes a base having a set of suction cups that removably adhere to the surface. The base may be removably attached to the article. The mount may be made of any one or combination of silicone, rubber, elastomeric polymers, and thermoplastics.

In some embodiments, the set of suction cups may include at least one suction cup having any one of a substantially hemispherical profile, a substantially pyramidical profile, or a rim thereof having a substantially rectangular contour with rounded edges. The set of suction cups may include at least one bellowed suction cup.

In some embodiments, the set of suction cups may include at least one suction cup having one or more grooves. Each suction cup of the set of suction cups may be arranged equidistantly from each adjacent suction cup. In some embodiments, the set of suction cups may include at least 24 suction cups arranged in a 6-by-4 grid.

In some embodiments, the set of suction cups may include a first subset of suction cups having a first diameter and a second subset of suction cups having a second diameter. The first diameter is greater than the second diameter. In some embodiments, the set of suction cups comprises a third subset of suction cups having a third diameter. The third diameter may be less than the first diameter and greater than the second diameter.

In some embodiments, each of the set of suction cups may include a flexible rim associated therewith. The set of suction cups may include a fourth subset of suction cups having a first rim distance and a fifth subset of suction cups having a second rim distance. The first rim distance may be greater than the second rim distance. In some embodiments, the set of suction cups may include a sixth subset of suction cups having a third rim distance. The third rim distance may be less than the first rim distance and greater than the second rim distance.

In some embodiments, the base is removably attached to the article by an adhering means. The adhering means is any one or combination of water-based adhesives, solvent-based adhesives, silicone adhesives, hydrogel adhesives, or acrylic adhesives. In some embodiments, adhering means may correspond to a pressure sensitive adhesive. In some embodiments, the adhering means may correspond to an adhesive that is washable such that when the adhesive is washed, one or more contaminants may be removed therefrom, and when the adhesive is dried, the adhesive's adhering properties are restored. In some embodiments, the adhesive may be removable and reuse-able.

In some embodiments, the base may have a length between about 6 centimeters and about 10 centimeters, a width between about 4 centimeters and about 6.5 centimeters, and a thickness between about 4 millimeters to about 8 millimeters.

In an aspect, a mount for supporting articles on a surface may include a base having a receptacle that accommodates an article, and a set of suction cups that removably adhere to the surface. The receptacle and the set of suction cups are defined on opposing sides of the base.

The following description is illustrative in nature and is not intended to be in any way limiting. In addition to the aforementioned illustrative aspects, embodiments, and features of the instant invention, further aspects, embodiments and features will become apparent by reference to the following detailed description.

### BRIEF DESCRIPTION OF THE ACCOMPANYING DRAWINGS

The accompanying drawings illustrate the best mode for carrying out the disclosure as instantly contemplated and set forth hereinafter. The instant disclosure may be more clearly understood from a consideration of the following detailed description of the preferred embodiments taken in conjunction with the accompanying drawings where all figures are diagrammatic and not to scale. Further, like reference letters and numerals indicate the corresponding parts in various figures in the accompanying drawings.

FIG. 1A illustrates an exemplary front view of a mount attached to an article for supporting the article on a surface, according to embodiments of present disclosure.

FIG. 1B illustrates an exemplary perspective view of the mount attached to the article, according to embodiments of present disclosure.

FIG. 2 illustrates an exemplary front view of the mount, according to embodiments of present disclosure.

FIG. 3A illustrates an exemplary view of a first embodiment of a set of suction cups, according to embodiments of present disclosure.

FIG. 3B illustrates an exemplary view of a second embodiment of the set of suction cups, according to embodiments of present disclosure.

FIG. 3C illustrates an exemplary view of a third embodiment of the set of suction cups, according to embodiments of present disclosure.

FIG. 3D illustrates an exemplary view of a fourth embodiment of the set of suction cups, according to embodiments of present disclosure.

FIG. 3E illustrates an exemplary view of a fifth embodiment of the set of suction cups, according to embodiments of present disclosure.

FIGS. 4A-4B illustrate exemplary cross-section views of the mount attached to the article for supporting the article on the surface, according to embodiments of present disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the invention as set forth.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “some embodiments” or “other embodiments” or “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, “substantially” means largely or considerably, but not necessarily wholly, or sufficiently to work for the intended purpose. The term “substantially” thus allows for minor, insignificant variations from an absolute or perfect state, dimension, measurement, result, or the like as would be expected by a person of ordinary skill in the art, but that do not appreciably affect overall performance.

As used herein, “about” means approximately or nearly, and in the context of a numerical value or range set forth means ±10% of the numeric value.

Existing mounts for supporting articles on surfaces are bulky, heavy and inconvenient to use. Often, such mounts include articulated arms and suction elements that consume excessive space, and are generally difficult to carry for daily use. Further, existing solutions using detachable suction cups often have to be attached to the article using adhesives, which are vulnerable to attract oil and dirt and incapable of being washed without deterioration of the adhesive properties.

Accordingly, in order to overcome at least the above-mentioned drawbacks associated with the existing mounts, embodiments of a mount for supporting articles on a surface are proposed. Some of the characteristics of the proposed mount include portability, simple construction and configuration, ease of operation, reusability and replaceability, improved adherence and retention, and the ability to adhere to uneven and/or curved surfaces.

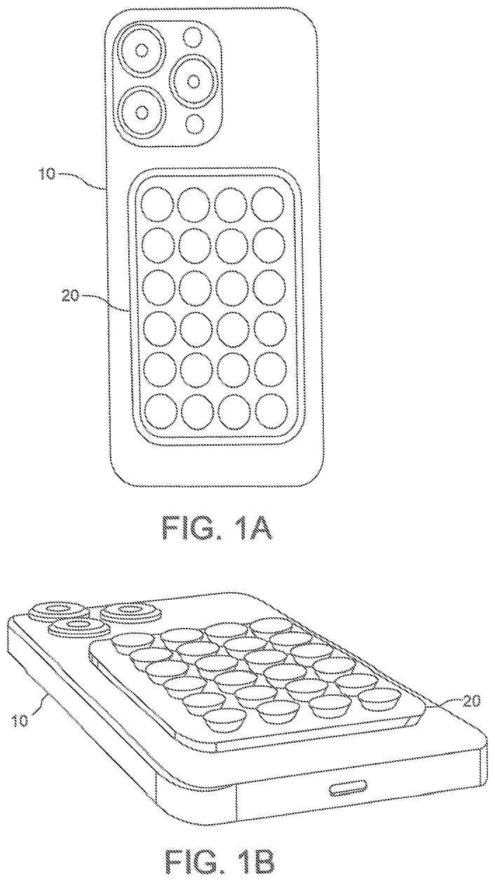

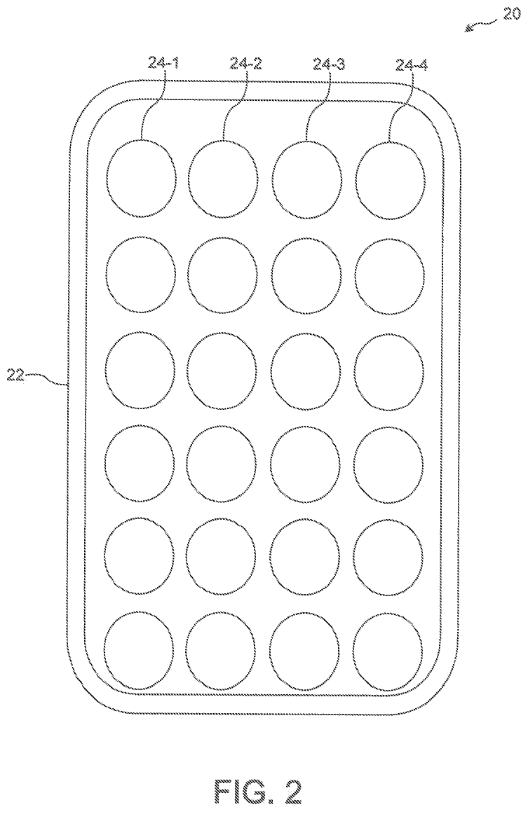

FIG. 1A illustrates an exemplary front view of a mount 20 attached to an article 10 for supporting the article 10 on a surface 30, and FIG. 1B illustrates an exemplary perspective view of the mount 20 attached to the article 10, according to embodiments of present disclosure. FIG. 2 illustrates an exemplary front view of the mount 20, according to embodiments of present disclosure. As shown, the mount 20 may include a base 22 and one or more suction cups, such as suction cups 24-1, 24-2, 24-3, and 24-4 (collectively referred to as set of suction cups 24).

In some embodiments, the article 10 may include but not be limited to, smartphones, cameras, cell phones, tablets, media players, and the like. FIGS. 1A and 1B illustrate exemplary embodiments where the article 10 is a smartphone. The article 10 may include a first side and a second side. The first side or the front side of the article 10 may correspond to the side having a visual unit, such as a touchscreen, of the article 10 with which a user may interact with the article 10. The second side or the rear side may be opposite to the first side of the article 10. As shown, the mount 20 may be attached to the second side or rear side of the article 10.

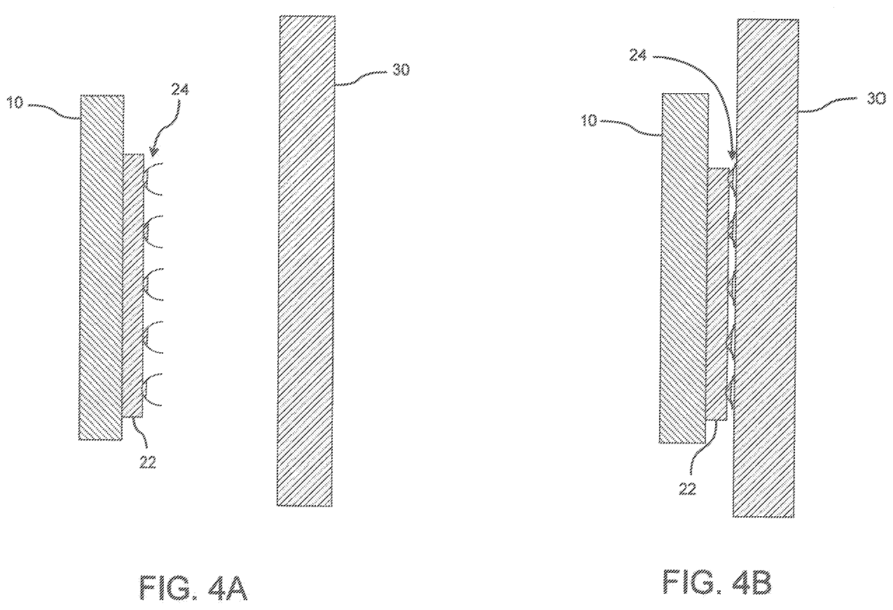

The mount 20 may allow the article 10 to be supported on a surface 30 (as shown and described further with respect to FIGS. 4A-4B). In some embodiments, the surface 30 may include, but not be limited to, windows, mirrors, cupboards, walls, tables, chairs, boards, signposts, vehicle exteriors, dashboards of vehicles, tiles, and the like. The mount 20 may be removably attached to the article 10. In some embodiments, the set of suction cups 24 may reversibly adhere to the surface 30, thereby allowing the article 10 to be reversibly supported on the surface 30.

In some embodiments, the mount 20 may be removably attached to the article 10 by an adhering means. The adhering means may include, but not be limited to, adhesives, interlocking elements, hook and loop fasteners, hook and slot fasteners, magnets, friction-grip releasable fasteners such as clips, clamps, grippers, and the like, and fastening straps such as elastic bands, straps, and the like. In some embodiments, the adhering means may be indicative of a portion of the base 22 having a plurality of microscopic elements that reversibly engage with the second side or the rear side of the article 10. In such embodiments, when the microscopic elements engage with the second side of the article 10, the base 22 may adhere to the article 10 due to van der Waal forces, for instance. In other embodiments, the adhering means may include one or more suction elements that reversibly adhere to the second side of the article 10.

In yet other embodiments, the adhering means may be any one or combination of adhesives including, but not limited to, water-based adhesives, solvent-based adhesives, silicone adhesives, hydrogel adhesives, acrylic adhesives, and the like. In some embodiments, the adhesive may correspond to a pressure sensitive adhesive. The pressure sensitive adhesive may be reactivatable on washing. The pressure sensitive adhesive may be made of hydrophobic silica. In some embodiments, the adhering means may correspond to an adhesive that is washable such that when the adhesive is washed, one or more contaminants may be removed therefrom, and when the adhesive is dried, the adhesive's adhering properties are restored. In such embodiments, the adhesive may be made of water-based adhesives or silicone adhesives. The one or more contaminants may include, but not be limited to oil, dirt, dust, and the like. The adhesive may be washed using a solution of detergent. In some embodiments, the adhesive may be air-dried for an hour for drying.

The adhesive may be applied to the base 22 of the mount 20 by methods including, but not limited to, spray coating, hot melting, extrusion application, die application, or other methods known for applying adhesives to substrates. The adhesive may allow the mount 20 to be removably and reuse-ably adhered to the second side of the article 10.

In some embodiments, the mount 20 may include a receptacle defined on the base 22 that accommodates the article 10. The receptacle may accommodate and securely hold the article 10 therein. The receptacle and the set of suction cups 24 may be defined on opposing sides of the base 22. In such embodiments, the receptacle may be indicative of an outer cover for the article 10, and the base 22 may be indicative of a portion on the outer cover. In an example where the article 10 is a smartphone, the outer cover may be indicative of a phone case.

In other embodiments, the mount 20 may be integrally affixed to the article 10. In such embodiments, the article 10 may have a provision to accommodate the mount 20 therein.

In some embodiments, the base 22 may have a substantially rectangular contour. In some embodiments, the base 22 may be substantially planar. In other embodiments, the base 22 may be substantially curved. The base 22 may be suitably adapted to conform to contours and dimensions of the article 10.

In some embodiments as an example, the base 22 may have a length between about 6 centimeters and about 10 centimeters. In an embodiment, the length of the base 22 may be about 8.44 centimeters. In some embodiments, the base 22 may have a width between about 4 centimeters and about 6.5 centimeters. In an embodiment, the width of the base 22 may be about 5.69 centimeters. In some embodiments, the base 22 may have a thickness between about 4 millimeters to about 8 millimeters. In an embodiment, the thickness of the base 22 may be about 6 millimeters. It may be appreciated by those skilled in the art that contours and dimensions of the base 22 may be suitably adapted for securely adhering to the article 10, and accommodate the set of suction cups 24 that adhered to the surface 30.

In some embodiments, the mount 20 may be made of any one material selected from a group including, but not limited to, rubber, silicone, elastomeric polymers, thermoplastics, and mixtures thereof. In a preferred embodiment, the mount 20 may be made of silicone. The silicone may be provided in a range of hardness to resiliently allow the base 22 and the set of suction cups 24 to flex and conform to the contours of the article 10 and the surface 30 respectively.

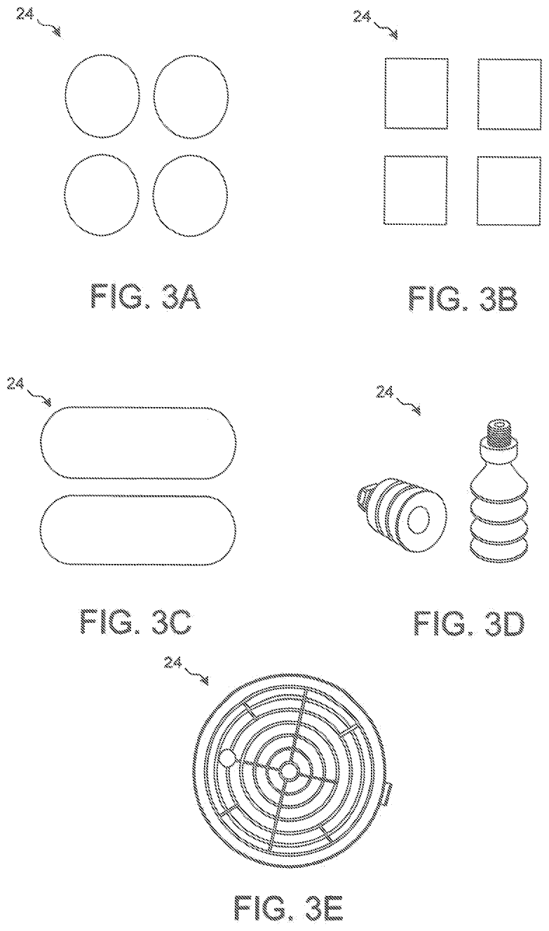

FIG. 3A-3E illustrates exemplary views of various embodiments of the set of suction cups 24. In a first embodiment as shown in FIG. 3A, at least one suction cup 24 from the set of suction cups 24 may have a substantially hemispherical profile. In a second embodiment as shown in FIG. 3B, at least one suction cup 24 from the set of suction cups 24 may have a substantially pyramidical profile, with a plurality of sides. In some embodiments, the suction cups 24 having the substantially pyramidal profile may have 4 sides, as shown in FIG. 3B. In other embodiments, the suction cups 24 may have 3 sides, or greater than 3 sides. In a third embodiment as shown in FIG. 3C, at least one suction cup 24 from the set of suction cups 24 may have a rim with a substantially rectangular contour with rounded edges.

In some embodiments with respect to FIG. 3A, the set of suction cups 24 may include a first subset of suction cups having a first diameter and a second subset of suction cups having a second diameter. The first diameter may be greater than the second diameter in certain embodiments. In some embodiments, the set of suction cups 24 may include a third subset of suction cups having a third diameter. The third diameter may be less than the first diameter and greater than the second diameter.

In some embodiments with respect to FIG. 3C, the set of suction cups 24 may include a fourth subset of suction cups having a first rim distance and a fifth subset of suction cups having a second rim distance. The first and second rim distances may be indicative of the distance between the base 22 and the rim of the suction cup 24. The first rim distance may be greater than the second rim distance in certain embodiments. In some embodiments, the set of suction cups 24 may include a sixth subset of suction cups having a third rim distance. The third rim distance may be less than the first rim distance and greater than the second rim distance.

The contours, dimensions and arrangements of the set of suction cups 24 may be suitably adapted based on the dimensions and weight of the article 10, and the contours of the surface 30. The contours and dimensions of the set of suction cups 24 may be adapted to maximize adherence to the surface 30. In some embodiments, the set of suction cups 24 may include any one or combination of including, but not limited to, a hemispherical suction cup, a pyramidical suction cup, and a suction cup with rounded edges.

In a fourth embodiment as shown in FIG. 3D, at least one suction cup from the set of suction cups 24 may be a bellowed suction cup. In such embodiments, the bellowed suction cups may include one or more foldable bellows. The bellowed suction cup may contract or expand to adhere to the surface 30. The bellowed suction cup may allow the mount 20 to adhere to an uneven surface.

In some embodiments, each of the suction cups from the set of suction cups 24 may be arranged equidistantly from each adjacent suction cup. In other embodiments, the set of suction cups 24 may be arranged in the form of a grid. In some embodiments, the set of suction cups 24 may include at least 24 suction cups arranged in a 6 by 4 grid. In other embodiments, the set of suction cups 24 may be arranged in a circular arrangement. In yet other embodiments, the set of suction cups 24 may be arranged in any suitable arrangement optimized based on the contours and dimensions of the article 10 and the surface 30.

In an example, one or more bellowed suction cups (24-1, 24-2) may be defined on a first portion of the base 22 and one or more hemispherical suction cups (24-3, 24-4) may be defined on a second portion of the base 22. The rim distance of the bellowed suction cups (24-1, 24-2) may be greater than the rim distance the hemispherical suction cup (24-3, 24-4). In such examples, the one or more bellowed suction cups (24-1, 24-2) may adhere to a dimpled portion of the surface 30 and the hemispherical suction cups (24-3, 24-4) may adhere to a flat portion of the surface 30. Since the bellowed suction cups (24-1, 24-2) have a greater rim distance than the hemispherical suction cups (24-3, 24-4), the mount 20 may support the article 10 substantially parallelly to the surface 30. Further, the set of suction cups 24 may engage substantially perpendicularly to the surface 30, thereby providing improved adhesion therebetween.

In other examples where the surface 30 is even, the one or more bellowed suction cups (24-1, 24-2) may also enable the article 10 to be supported on the surface 30 with an inclination with respect to the ground. In such examples, the mount 20 may also function as an apparatus to tilt the article 10 with respect to the surface 30, thereby allowing users to operate the article 10 more conveniently, such as for viewing videos on the front side of the article 10 such as a smartphone.

In a fifth embodiment as shown in FIG. 3E, the set of suction cups 24 may include at least one suction cup 24 having one or more grooves. The one or more grooves may provide one or more channels for evacuating the fluid when the rim of the set of suction cups 24 flexes in response to the mount 20 being pressed against the surface 30.

In some embodiments, the one or more grooves may be arranged in a spiral manner. In other embodiments, the one or more grooves may be arranged in a grid. The one or more grooves may be arranged to have one or more channels for optimizing evacuation of the fluid when the rim of the set of suction cups 24 flexes. The one or more grooves may be arranged to maximize friction between the suction cup 24 and the surface 30, thereby preventing the suction cup 24 from popping off due to changes in air pressure or de-adhering due to sudden disturbances or movements. In other embodiments, each of the suction cups 24 may have a smooth surface.

FIGS. 4A-4B illustrate exemplary cross-section views of the mount 20 attached to the article 10 for supporting the article 10 on the surface 30, according to embodiments of present disclosure. FIG. 4A shows a cross-section view before the mount 20 is adhered to the surface 30, and FIG. 4B shows a cross-section view after the mount 20 is adhered to the surface 30. Each suction cup from the set of suction cups 24 may have the flexible rim associated therewith. The rim may be flexible such that the rim resiliently flexes when pressed against the surface 30. The deformation creates a vacuum between the set of suction cups 24 and the surface 30, thereby enabling the set of suction cups 24 to adhere to the surface 30. The mount 20 may then support the article 10 attached thereto on the surface 30. By pulling the mount 20 away from the surface 30, the rim may flex to allow a fluid, such as air, to enter in between the set of suction cups 24 and the surface 30, thereby de-adhering the set of suction cups 24 from the surface 30.

The mount 20 may allow the article 10 to be supported on the surface 30 in any orientation. In some embodiments, the surface 30 may be substantially vertical, such as a wall surface, a cupboard surface, a mirror surface, or a window surface. In such embodiments, the mount 20 may be adhered to the surface 30 such that the article 10 is in a substantially vertical orientation. The article 10 may be supported perpendicularly with respect to the ground.

In other embodiments, the surface 30 may be inclined. In an example, the inclined surface 30 may be indicative of a windshield of a vehicle, or an automotive dashboard. In such cases, the mount 20 may be adhered to the inclining surface 30 such that the article 10 is in a substantially inclined orientation with respect to the ground.

In other embodiments, the surface 30 may be substantially horizontal, such as on a substrate or a portion underneath a table, a vehicle or a support structure. In an example, the user may place a support structure over a bed such that the support structure is configured to hover over the bed. The mount 20 may be adhered to the support structure such that the article 10 is substantially parallel with respected to the ground/bed. The mount 20 may support the article 10 against the force of gravity, thereby allowing the user to view and interact with the article 10 while sitting or lying down on the bed. In other examples, the user may reversibly fix the article 10, such as a smartphone, to a bottom of a vehicle to allow an automobile mechanic to view instructions on the smartphone while operating underneath the vehicle.

The instant disclosure provides a mount for supporting articles on surfaces. The mount solves the problems of existing solutions by providing a convenient, efficient, simple and easy to use mount for supporting articles of various shapes, contours and sizes, and on various surfaces, such as, but not limited to, uneven curved surfaces. Further, the mount is attached to the article by adhering means that are reusable and retain adhesive properties on wash.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

The skilled person will be aware of a range of possible modifications of the various embodiments described above. Accordingly, the present invention is defined by the claims and their equivalents.

What is claimed is:

1. A mount for supporting an article on a surface, comprising:
a base having a set of suction cups that removably adhere to the surface, wherein the base is removably attached to the article.

2. The mount of claim 1, wherein the mount is made of any one or combination of silicone, rubber, elastomeric polymers, and thermoplastics.

3. The mount of claim 1, wherein the set of suction cups comprises at least one suction cup having any one of a substantially hemispherical profile, a substantially pyramidical profile, or a rim thereof having a substantially rectangular contour with rounded edges.

4. The mount of claim 1, wherein the set of suction cups comprises at least one bellowed suction cup.

5. The mount of claim 1, wherein the set of suction cups comprises at least one suction cup having one or more grooves.

6. The mount of claim 1, wherein each suction cup of the set of suction cups is arranged equidistantly from each adjacent suction cup.

7. The mount of claim 1, wherein the set of suction cups comprises at least 24 suction cups arranged in a 6-by-4 grid.

8. The mount of claim 1, wherein the set of suction cups comprises a first subset of suction cups having a first diameter and a second subset of suction cups having a second diameter, wherein the first diameter is greater than the second diameter.

9. The mount of claim 8, wherein the set of suction cups comprises a third subset of suction cups having a third diameter, the third diameter is less than the first diameter and greater than the second diameter.

10. The mount of claim 1, wherein each of the set of suction cups comprise a flexible rim.

11. The mount of claim 10, wherein the set of suction cups comprises a fourth subset of suction cups having a first rim distance and a fifth subset of suction cups having a second rim distance, wherein the first rim distance is greater than the second rim distance.

12. The mount of claim 11, wherein the set of suction cups comprises a sixth subset of suction cups having a third rim distance, wherein the third rim distance is less than the first rim distance and greater than the second rim distance.

13. The mount of claim 1, wherein the base is removably attached to the article by an adhering means.

14. The mount of claim 13, wherein the adhering means is any one or combination of water-based adhesives, solvent-based adhesives, silicone adhesives, hydrogel adhesives, or acrylic adhesives.

15. The mount of claim 13, wherein the adhering means corresponds to a pressure sensitive adhesive.

16. The mount of claim 13, wherein the adhering means corresponds to an adhesive that is washable such that when the adhesive is washed, one or more contaminants are removed therefrom, and when the adhesive is dried, the adhesive's adhering properties are restored.

17. The mount of claim 1, wherein the base has a length between about 6 centimeters and about 10 centimeters, a width between about 4 centimeters and about 6.5 centimeters, and a thickness between about 4 millimeters to about 8 millimeters.

18. A mount for supporting articles on a surface, comprising:
a base having a receptacle that accommodates an article, and a set of suction cups that removably adhere to the surface.

19. The mount of claim 18, wherein the receptacle and the set of suction cups are defined on opposing sides of the base.
